(19) United States
(12) Patent Application Publication
(10) Pub. No.: US 2026/0071584 A1
(43) Pub. Date: Mar. 12, 2026

(54) AIR-FUEL RATIO CONTROL METHOD AND DEVICE FOR INTERNAL COMBUSTION ENGINE

(71) Applicant: NISSAN MOTOR CO., LTD., Yokohama-shi, Kanagawa (JP)

(72) Inventors: Tomohiro SAKATA, Kanagawa (JP); Daiki NISHI, Kanagawa (JP)

(73) Assignee: NISSAN MOTOR CO., LTD., Yokohama-shi, Kanagawa (JP)

(21) Appl. No.: 19/107,554

(22) PCT Filed: Sep. 1, 2022
(86) PCT No.: PCT/JP2022/032936

§ 371 Date: Feb. 27, 2025

(51) Int. Cl. F02D 41/14

(52) U.S. Cl. CPC F02D 41/1454; F02D 41/1441; F02D 2200/0814

(57) ABSTRACT

The oxygen storage amount of a three-way catalyst is estimated based on an upstream-side exhaust air-fuel ratio, and a target air-fuel ratio is controlled such that the estimated oxygen storage amount matches a predetermined target oxygen storage amount. When a downstream-side exhaust air-fuel ratio detected by a downstream-side air-fuel ratio sensor is equal to or less than a threshold value corresponding to a first oxygen storage amount, the estimated oxygen storage amount is reset to the value of first oxygen storage amount. When downstream-side exhaust air-fuel ratio is equal to or greater than a threshold value corresponding to a second oxygen storage amount, the estimated oxygen storage amount is reset to the value of second oxygen storage amount. The target oxygen storage amount is set to be closer to first oxygen storage amount than the median of first oxygen storage amount and second oxygen storage amount.

### TECHNICAL FIELD

The present invention relates to a control method and device for controlling an air-fuel ratio such that the oxygen storage amount of an exhaust purifying catalyst provided in an exhaust passage of an internal combustion engine is maintained at a target oxygen storage amount.

### BACKGROUND TECHNOLOGY

Although, for example, a three-way catalyst as an exhaust purifying catalyst is capable of oxidizing CO and HC and reducing NOx in the exhaust gas, in order to achieve a high level of both oxidation and reduction by catalytic action, it is important for the catalyst to be able to absorb, store and release oxygen, the so-called oxygen storage amount. Therefore, a technique has been known to estimate the amount of oxygen storage in the three-way catalyst and control a target air-fuel ratio to maintain this oxygen storage amount within an appropriate range.

A patent document 1 discloses a technique in which a downstream-side air-fuel ratio sensor is provided on the downstream side of the exhaust purifying catalyst, and a target air-fuel ratio is switched to a lean air-fuel ratio when the air-fuel ratio detected by the downstream-side air-fuel ratio sensor reaches a rich determination air-fuel ratio, and the target air-fuel ratio is switched to a rich air-fuel ratio when it reaches a lean determination air-fuel ratio. In addition, as one-side breakdown control, after the target air-fuel ratio is switched to a lean air-fuel ratio, when the estimated oxygen storage amount reaches a predetermined switching reference storage amount, the target air-fuel ratio is switched to a rich air-fuel ratio.

However, the technique of this patent document 1 is basically one that actively increases or decreases the oxygen storage amount in the exhaust purifying catalyst, and does not attempt to converge the oxygen storage amount to a certain target oxygen storage amount. When the air-fuel ratio detected by the downstream-side air-fuel ratio sensor becomes the rich determination air-fuel ratio, CO and HC have already started to flow out of the exhaust purifying catalyst. Similarly, when the detected air-fuel ratio becomes the lean determination air-fuel ratio, NOx has already started to flow out of the exhaust purifying catalyst. In particular, since NOx has the characteristic of increasing rapidly on the downstream-side of the exhaust purifying catalyst when the oxygen storage amount exceeds a level corresponding to the lean determination air-fuel ratio, NOx emissions exceeding an allowable level are likely to occur due to control delays.

### PRIOR ART REFERENCE(S)

### Patent Document(s)

Patent Document 1: Japanese Patent Application Publication No. 2015-71959

### SUMMARY OF THE INVENTION

The present invention is a method for controlling an air-fuel ratio of an internal combustion engine provided with an exhaust purifying catalyst having an oxygen storage capacity in an exhaust passage by controlling the air-fuel ratio such that an oxygen storage amount of the exhaust purifying catalyst becomes a target oxygen storage amount, the method including: estimating the oxygen storage amount of the exhaust purifying catalyst based on an air-fuel ratio of an exhaust gas flowing into the exhaust purifying catalyst; controlling the air-fuel ratio of the internal combustion engine such that the estimated oxygen storage amount matches the target oxygen storage amount; detecting an air-fuel ratio of an exhaust gas flowing out of the exhaust purifying catalyst, on a downstream side of the exhaust purifying catalyst; resetting the estimated oxygen storage amount to a predetermined first oxygen storage amount which is smaller than the target oxygen storage amount when it is detected that the oxygen storage amount of the exhaust purifying catalyst is equal to or smaller than the first oxygen storage amount based on the air-fuel ratio of the exhaust gas flowing out of the exhaust purifying catalyst; and resetting the estimated oxygen storage amount to a predetermined second oxygen storage amount which is larger than the target oxygen storage amount when it is detected that the oxygen storage amount of the exhaust purifying catalyst is equal to or larger than the second oxygen storage amount based on the air-fuel ratio of exhaust gas flowing out of the exhaust purifying catalyst, wherein the target oxygen storage amount is set within a range where the oxygen storage amount is smaller than a median of the first oxygen storage amount and the second oxygen storage amount.

In the above configuration, since the air-fuel ratio of the internal combustion engine is controlled such that the estimated exhaust storage amount matches the target oxygen storage amount, ideally, the actual oxygen storage amount of the exhaust purifying catalyst is maintained near the target oxygen storage amount. If the estimated oxygen storage amount deviates from the actual oxygen storage amount due to disturbance or some other factor, for example, the air-fuel ratio of the exhaust gas flowing out of the exhaust purifying catalyst could be an air-fuel ratio corresponding to the first oxygen storage amount or less due to the actual oxygen storage amount being under-estimated. By this, it is detected that the actual oxygen storage amount is equal to or smaller than the first oxygen storage amount. Alternatively, due to the excessive actual oxygen storage amount, the air-fuel ratio of the exhaust gas flowing out of the exhaust purifying catalyst could be an air-fuel ratio corresponding to the second oxygen storage amount or greater. By this, it is detected that the actual oxygen storage amount is equal to or larger than the second oxygen storage amount.

At such times, the estimated oxygen storage amount is reset to the first oxygen storage amount or second oxygen storage amount, respectively. As a result, a large difference between the estimated oxygen storage amount and the target oxygen storage amount appears, and the air-fuel ratio of the internal combustion engine is controlled in a manner corresponding to each of them.

In the present invention, the target oxygen storage amount is set not at the median of the first oxygen storage amount and second oxygen storage amount, but at the side with smaller oxygen storage amount, namely, closer to the first oxygen storage amount. In other words, the difference in oxygen storage amount from the target oxygen storage amount to the first oxygen storage amount is larger than the difference in oxygen storage amount from the target oxygen storage amount to the second oxygen storage amount. Therefore, when there is an estimation error due to disturbance or some other factor, the frequency at which the estimated oxygen storage amount is reset when the actual oxygen storage amount reaches the second oxygen storage amount is relatively less, as compared with the frequency at which the estimated oxygen storage amount is reset when the actual oxygen storage amount reaches the first oxygen storage amount. Consequently, NOx emissions, which have the characteristic of increasing rapidly when the oxygen storage amount becomes equal to or larger than the second oxygen storage amount, are suppressed.

### BRIEF DESCRIPTION OF THE DRAWINGS

FIG. 1 is an illustrative view of the configuration of an internal combustion engine in one embodiment which is provided with a three-way catalyst.

FIG. 2 is a characteristic diagram showing the relationship of the oxygen storage amount of the three-way catalyst and CO and NOx flowing out of the three-way catalyst.

FIG. 3 is a flowchart of an air-fuel ratio control in one embodiment.

FIG. 4 is a block diagram relating to the calculation of a target air-fuel ratio.

FIG. 5 is a time chart showing changes in a downstream-side air-fuel ratio, an oxygen storage amount and a target air-fuel ratio.

### MODE FOR IMPLEMENTING THE INVENTION

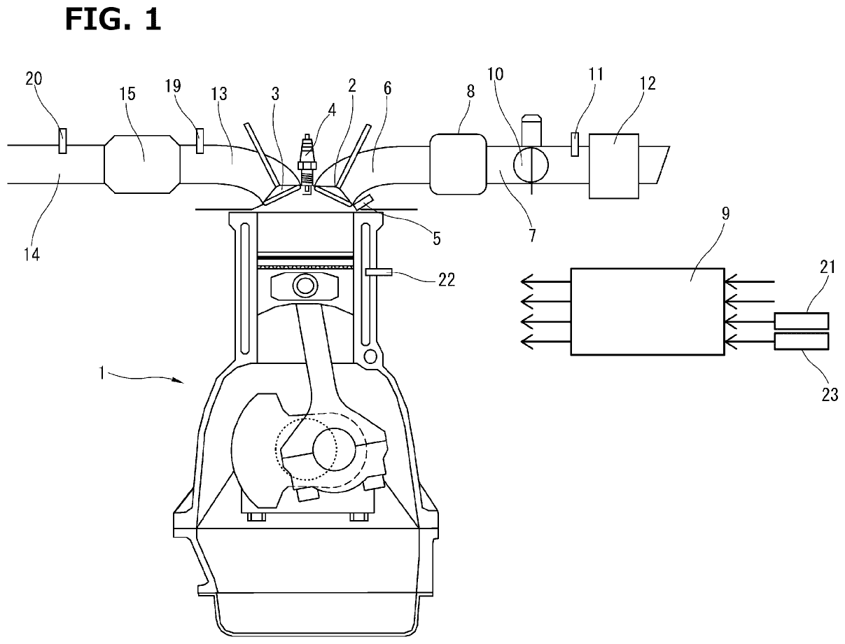

In the following, one embodiment of the present invention will be explained in detail based on the drawings. FIG. 1 is an illustrative view showing the schematic configuration of an internal combustion engine 1 in one embodiment to which the present invention is applied. Internal combustion engine 1 in one embodiment is a four-stroke cycle spark-ignition internal combustion engine (so-called gasoline engine), and is equipped with an intake valve 2, an exhaust valve 3 and a spark plug 4 in each cylinder. In addition, in the illustration, it is configured as a cylinder direct-injection engine, and a fuel injection valve 5 which injects fuel into a cylinder is disposed, for example, on the intake valve 2 side. In addition, internal combustion engine 1 may have a port injection type configuration in which fuel is injected toward an intake port 6.

An electronically controlled throttle valve 10, the opening degree of which is controlled by a control signal from an engine controller 9, is interposed on the upstream side of a collector portion 8 in an intake passage 7 connected to intake port 6 of each cylinder. An air flow meter 11 which detects the amount of intake air is disposed on the upstream side of throttle valve 10, and an air cleaner 12 is disposed on the further upstream side.

Exhaust ports 13 of respective cylinders are assembled as a single exhaust passage 14, and in this exhaust passage 14, an exhaust purifying catalyst, such as a three-way catalyst 15, is provided for exhaust purification. Three-way catalyst 15 is, for example, a so-called monolithic ceramic catalyst in which a catalyst layer containing a catalyst metal is coated on the surface of a monolithic ceramic body in which fine passages are formed. In addition, Three-way catalyst 15 may further include a downstream-side catalyst arranged in series (so-called under-floor catalyst).

At the inlet side of three-way catalyst 15 in exhaust passage 14, that is, the upstream side of three-way catalyst 15, an upstream-side air-fuel ratio sensor 19 is disposed to detect the air-fuel ratio of exhaust gas discharged by internal combustion engine 1 (in other words, the air-fuel ratio of exhaust gas entering into three-way catalyst 15). Upstream-side air-fuel ratio sensor 19 is a so-called wide-area air-fuel ratio sensor that produces an output corresponding to the exhaust air-fuel ratio. In addition, a downstream-side air-fuel ratio sensor 20 which detects the air-fuel ratio of the exhaust gas flowing out of three-way catalyst 15 is disposed at the outlet side or downstream side of three-way catalyst 15. Similar to upstream-side air-fuel ratio sensor 19, downstream-side air-fuel ratio sensor 20 is a wide-area air-fuel ratio sensor that produces an output according to the exhaust air-fuel ratio.

Detection signals of air-fuel ratio sensors 19 and 20 and air flow meter 11 are input to engine controller 9. In addition, engine controller 9 is input with detection signals from a plurality of sensors, such as a crank angle sensor 21 for detecting the engine rotation speed, a water temperature sensor 22 for detecting the cooling water temperature, and an accelerator pedal opening degree sensor 23 for detecting the amount of depressing the accelerator pedal operated by a driver. Based on these input signals, engine controller 9 optimally controls the amount and timing of fuel injection by fuel injection valve 5, the ignition timing by spark plug 4, the opening degree of throttle valve 10 and the like.

As one of the various controls of internal combustion engine 1, engine controller 9 is configured to perform air-fuel ratio control to maintain the oxygen storage amount of three-way catalyst 15 at a target oxygen storage amount in order to optimize the exhaust purification performance of three-way catalyst 15. In the air-fuel ratio control, the fuel injection amount is controlled by feedback control (for example, PID control) such that the exhaust air-fuel ratio detected by upstream-side air-fuel ratio sensor 19 (hereinafter referred to as “upstream-side exhaust air-fuel ratio”) is in accordance with a target air-fuel ratio. Here, the target air-fuel ratio is calculated such that the oxygen storage amount of three-way catalyst 15, which is estimated from the upstream-side exhaust air-fuel ratio, matches the target oxygen storage amount. Therefore, basically, the oxygen storage amount of three-way catalyst 15 is maintained near the target oxygen storage amount.

On the other hand, if the estimated oxygen storage amount deviates from an actual oxygen storage amount due to some disturbance or estimation error, the actual oxygen storage amount of three-way catalyst 15 becomes smaller or larger than the target oxygen storage amount, and the air-fuel ratio of the exhaust gas flowing out of three-way catalyst 15, that is, the exhaust air-fuel ratio detected by downstream-side air-fuel ratio sensor 20 (hereafter, this is referred to as “downstream-side exhaust air-fuel ratio”) changes to the rich side or the lean side. Based on these changes in the downstream-side exhaust air-fuel ratio, the estimated oxygen storage amount is reset to be in accordance with the actual oxygen storage amount.

That is, in the above embodiment, a first oxygen storage amount OSA1, where the oxygen storage amount is smaller than the target oxygen storage amount, and a second oxygen storage amount OSA2, where the oxygen storage amount is larger than the target oxygen storage amount, are preset, and threshold values RAF1 and RAF2 for the downstream-side exhaust air-fuel ratio are given for first and second oxygen storage amounts OSA1 and OSA2, respectively. Threshold value RAF1 is set on the slightly richer side than the air-fuel ratio equivalent to the theoretical air-fuel ratio, and threshold value RAF2 is set on the slightly leaner side than the air-fuel ratio equivalent to the theoretical air-fuel ratio. When the downstream-side exhaust air-fuel ratio detected by downstream-side air-fuel ratio sensor 20 becomes equal to or less than threshold value RAF1, the actual oxygen storage amount of three-way catalyst 15 is considered to be first oxygen storage amount OSA1 or smaller, and the estimated oxygen storage amount is reset using the value of first oxygen storage amount OSA1. Similarly, when the downstream-side exhaust air-fuel ratio detected by downstream-side air-fuel ratio sensor 20 becomes equal to or greater than threshold value RAF2, the actual oxygen storage amount of three-way catalyst 15 is considered to be second oxygen storage amount OSA2 or larger, and the estimated oxygen storage amount is reset using the value of second oxygen storage amount OSA2.

In this way, by resetting the estimated oxygen storage amount using the value of first oxygen storage amount OSA1 or second oxygen storage amount OSA2, the accuracy of the estimated oxygen storage amount is ensured. At the same time, by resetting the estimated oxygen storage amount, a large difference between the estimated oxygen storage amount and the target oxygen storage amount appears, and the air-fuel ratio of internal combustion engine 1 (in other words, fuel injection amount) is controlled in response to each of them, such that the actual oxygen storage amount of three-way catalyst 15 quickly approaches the target oxygen storage amount.

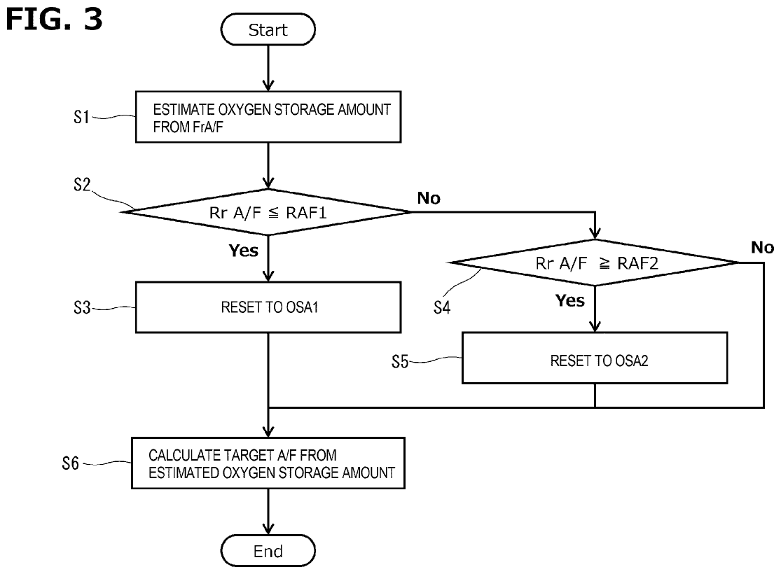

FIG. 3 is a flowchart showing the air-fuel ratio control based on the oxygen storage amount. In a step 1, the oxygen storage amount of three-way catalyst 15 is estimated based on the upstream-side exhaust air-fuel ratio (FrA/F) detected by upstream-side air-fuel ratio sensor 19 and the intake air amount detected by air flow meter 11, which corresponds to the gas flow rate flowing into three-way catalyst 15. In addition, the “intake air amount” does not mean the amount of air per cylinder cycle, but rather the flow rate of air per unit time that is sucked into internal combustion engine 1 (that is, passes through air flow meter 11). The estimated oxygen storage amount is obtained by adding or subtracting the oxygen storage amount based on the upstream-side exhaust air-fuel ratio at that time for each calculation cycle of engine controller 9. That is, simply put, since when the exhaust air-fuel ratio of exhaust gas flowing into three-way catalyst 15 is lean, the oxygen storage amount increases, and when it is rich, the oxygen storage amount decreases, the oxygen storage amount at that point is estimated by integrating with both positive and negative values.

In step 2, the downstream-side exhaust air-fuel ratio (RrA/F) detected by downstream-side air-fuel ratio sensor 20 is compared with threshold value RAF1 corresponding to first oxygen storage amount OSA1 mentioned above. When the downstream-side exhaust air-fuel ratio is equal to or less than threshold value RAF1, the step proceeds from step 2 to a step 3, and the estimated oxygen storage amount is reset to the value of first oxygen storage amount OSA1. Then, after the reset, the step proceeds to a step 6. When the downstream-side exhaust air-fuel ratio is greater than threshold value RAF1, the step proceeds to a step 4 and the downstream-side exhaust air-fuel ratio is compared with threshold value RAF2 corresponding to second oxygen storage amount OSA2 described above. When the downstream-side exhaust air-fuel ratio is equal to or greater than threshold value RAF2, the step proceeds from step 4 to a step 5, and the estimated oxygen storage amount is reset to the value of second oxygen uptake OSA2. Then, after the reset, the step proceeds to step 6.

When the downstream-side exhaust air-fuel ratio is between two threshold values RAF1 and RAF2 that sandwich the theoretical air-fuel ratio, the value of the estimated oxygen storage amount estimated in step 1 is held, and the step proceeds to step 6.

In step 6, based on the estimated oxygen storage amount and a predetermined target oxygen storage amount, a required target air-fuel ratio is calculated such that the estimated oxygen storage amount matches the target oxygen storage amount.

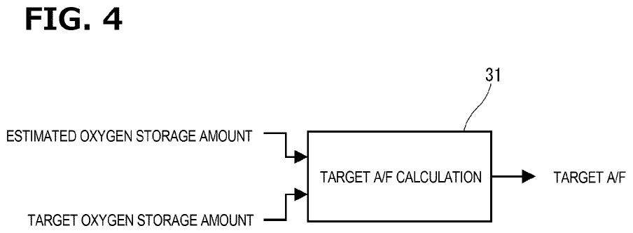

FIG. 4 is a block diagram showing the process of step 6, and the difference between the estimated oxygen storage amount and the target oxygen storage amount is obtained in a target air-fuel ratio calculation section 31, and a target air-fuel ratio is calculated such that the oxygen storage amount changes at an appropriate rate. For example, when the estimated oxygen storage amount is larger than the target oxygen storage amount, the target air-fuel ratio is set richer than the theoretical air-fuel ratio. Conversely, when the estimated oxygen storage amount is smaller than the target oxygen storage amount, the target air-fuel ratio is set leaner than the theoretical air-fuel ratio. In addition, since the fuel injection amount is controlled so as to achieve the target air-fuel ratio, this target air-fuel ratio can basically be regarded as equal to the air-fuel ratio of the exhaust gas discharged from internal combustion engine 1, that is, the upstream-side exhaust air-fuel ratio detected by upstream-side air-fuel ratio sensor 19.

By such a process, the oxygen storage amount of three-way catalyst 15 is maintained near the target oxygen storage amount, and the downstream-side exhaust air-fuel ratio detected by downstream-side air-fuel ratio sensor 20 is ideally between two threshold values RAF1 and RAF2. Thus, oxidation of CO and HC and reduction of NOx in exhaust gas are effectively performed.

Here, in the present invention, the target oxygen storage amount is not the median of first oxygen storage amount OSA1 and second oxygen storage amount OSA2, but is set within the range where the oxygen storage amount is smaller than the median. In addition, although the oxygen storage amount can be treated in terms of the mass of oxygen (unit “g”), conventionally, it can be expressed as a percentage of the maximum oxygen storage amount of three-way catalyst 15, which is 100 (%).

In one example, first oxygen storage amount OSA1 is larger than 10% of the maximum oxygen storage amount of three-way catalyst 15, and second oxygen storage amount OSA2 is smaller than 90% of the maximum oxygen storage amount of three-way catalyst 15. In addition, the target oxygen storage amount is smaller than 40% of the maximum oxygen storage amount of three-way catalyst 15.

In a preferable one embodiment, first oxygen storage amount OSA1 is 20% of the maximum oxygen storage amount of three-way catalyst 15, and second oxygen storage amount OSA2 is 60% of the maximum oxygen storage amount of three-way catalyst 15. In addition, the target oxygen storage amount is 35% of the maximum oxygen storage amount of three-way catalyst 15.

In this way, the target oxygen storage amount is set not at the median of first oxygen storage amount OSA1 and second oxygen storage amount OSA2, but at the side with smaller oxygen storage amount, namely, closer to first oxygen storage amount OSA1. In other words, as compared with the difference in oxygen storage amount from the target oxygen storage amount to first oxygen storage amount OSA1, the difference in oxygen storage amount from the target oxygen storage amount to second oxygen storage amount OSA2 is large. Consequently, If there is an estimation error due to disturbance or some other factor, the frequency at which the actual oxygen storage amount reaches second oxygen storage OSA2 and the estimated oxygen storage amount is reset is relatively less, as compared with the frequency at which the actual oxygen storage amount reaches first oxygen storage amount OSA1 and the estimated oxygen storage amount is reset.

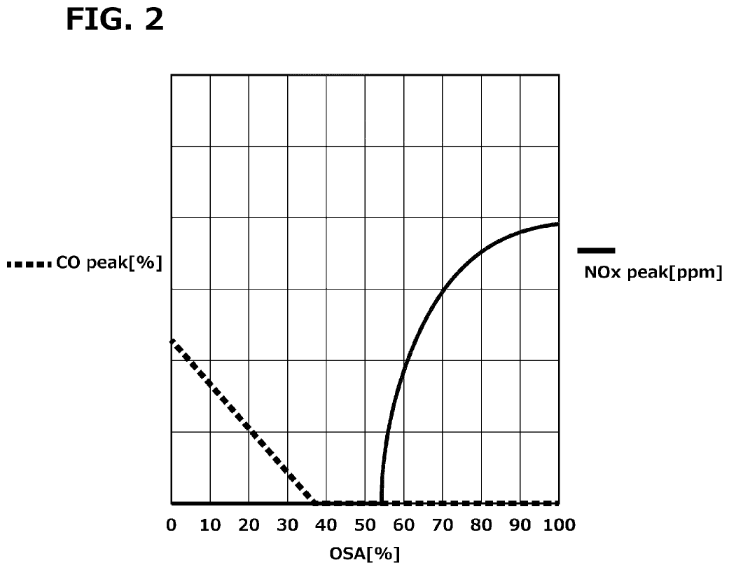

FIG. 2 is a characteristic diagram schematically showing the relationship between the oxygen storage amount of three-way catalyst 15 and CO and NOx flowing out of three-way catalyst 15. As illustrated, both CO emissions and NOx emissions are minimized when the oxygen storage amount of three-way catalyst 15 is within a certain intermediate range. When the oxygen storage amount becomes smaller than a certain level, CO flows out of three-way catalyst 15. The emission amount of this CO increases proportionally with the decrease in oxygen storage amount. The same trend applies to HC that needs to be oxidized.

In contrast to this, as for NOx, NOx stars to flow out of three-way catalyst 15 when the oxygen storage amount becomes greater than a certain level, and the emission amount of this NOx has the characteristic of increasing rapidly when the oxygen storage amount exceeds a certain level. Then, as oxygen storage amount approaches 100%, the gradient of NOx increase becomes slower.

Basically, first oxygen storage amount OSA1 is set to an oxygen storage amount that is the allowable limit of CO flowing out toward the downstream side of three-way catalyst 15, and second oxygen storage amount OSA2 is set to an oxygen storage amount that is the allowable limit of NOx flowing out toward the downstream side of three-way catalyst 15. However, for example, when the estimated oxygen storage amount is reset to first oxygen storage amount OSA1 as the oxygen storage amount is equal to or smaller than first oxygen storage amount OSA1 based on the downstream-side exhaust air-fuel ratio, there is a delay until the air-fuel ratio of internal combustion engine 1 becomes lean with the reset of the estimated oxygen storage amount and the actual oxygen storage amount starts to increase and CO outflow is suppressed. Similarly, when the estimated oxygen storage amount is reset to second oxygen storage amount OSA2 as the oxygen storage amount is larger than second oxygen storage amount OSA2 based on the downstream-side exhaust air-fuel ratio, there is a delay until the air-fuel ratio of internal combustion engine 1 becomes rich with the reset of the estimated oxygen storage amount and the actual oxygen storage amount starts to decrease and NOx outflow is suppressed. Here, since CO tends to increase proportionally to the oxygen storage amount as mentioned above, there is relatively little CO leakage associated with such a delay. In contrast to this, since NOx has a tendency to increase rapidly, the NOx outflow associated with the delay is significant.

In the above embodiment, since the target oxygen storage amount is set to be closer to first oxygen storage amount OSA1, which has a smaller oxygen storage amount than the median of first oxygen storage amount OSA1 and second oxygen storage amount OSA2, as compared with the frequency at which the actual oxygen storage amount reaches first oxygen storage amount OSA1 and the estimated oxygen storage amount is reset, the frequency at which the actual oxygen storage amount reaches second oxygen storage amount OSA2 and the estimated oxygen storage amount is reset is relatively less. Consequently, NOx outflow mentioned above is suppressed.

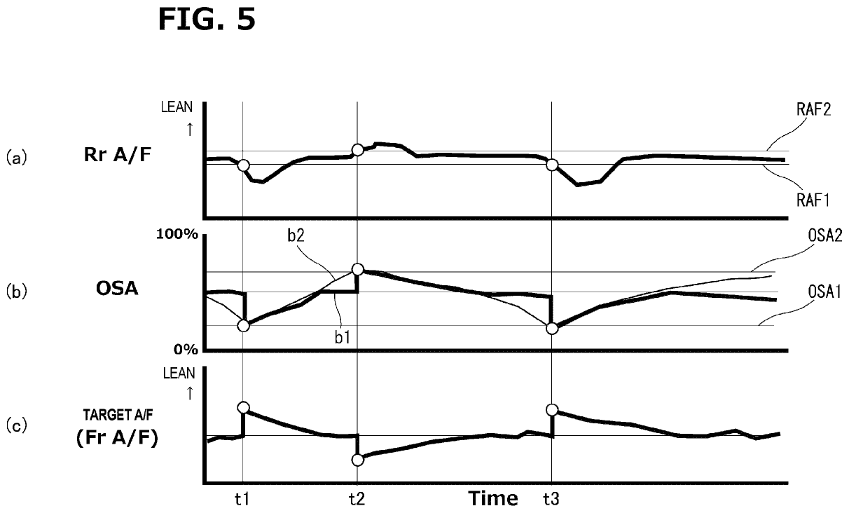

FIG. 5 is a time chart showing one example of changes in an oxygen storage ament and the like which are controlled in the above embodiment. From the top of the figure, (a) downstream-side exhaust air-fuel ratio (RrA/F), (b) oxygen storage amount, and (c) target air-fuel ratio are shown. The target air-fuel ratio is also an upstream-side exhaust air-fuel ratio (FrA/F). An estimated oxygen storage amount b1 and an actual oxygen storage amount b2 are superimposed in the column (b) oxygen storage amount column.

In the example of this time chart, at a time t1, the downstream-side exhaust air-fuel ratio becomes equal to or less than threshold value RAF1 corresponding to first oxygen storage amount OSA1, and accordingly, estimated oxygen storage amount b1 is reset to first oxygen storage amount OSA1. Therefore, the target air-fuel ratio changes stepwise to the lean side.

In addition, at a time t2, the downstream-side exhaust air-fuel ratio becomes equal to or greater than threshold value RAF2 corresponding to second oxygen storage amount OSA2, and accordingly, estimated oxygen storage amount b1 is reset to second oxygen storage amount OSA2. Therefore, the target air-fuel ratio changes stepwise to the rich side. At a time t3, the downstream-side exhaust air-fuel ratio becomes equal to or less than threshold value RAF1, estimated oxygen storage amount b1 is reset to first oxygen storage amount OSA1, and the target air-fuel ratio changes stepwise to the lean side.

In addition, FIG. 5 is one exaggeratingly drawn to illustrate the reset operation, and as mentioned above, ideally, the downstream-side exhaust air-fuel ratio is maintained between two threshold values RAF1 and RAF2, and the air-fuel ratio control based on estimated oxygen storage amount b1 is continued without resetting. In addition, the reset by threshold value RAF1 and the reset by threshold value RAF2 are not necessarily performed alternately.

As the above, one embodiment of the present invention has been explained, the present invention is not limited to the above embodiment, and various changes might be made to the embodiment. For example, in the above embodiment, although three-way catalyst 15 is illustrated as an exhaust purifying catalyst, the present invention can be similarly applied to exhaust purifying catalysts having oxygen storage capacity other than three-way catalysts.

In addition, although not shown in detail, when a temporary stop of internal combustion engine 1 is requested in an idle stop or series hybrid vehicle, it is desirable to perform operation for setting the air-fuel ratio of internal combustion engine 1 to be rich such that the oxygen storage amount of three-way catalyst 15 is smaller than the target oxygen storage amount before the temporary stop is executed. Consequently, the NOx emissions in the initial stage of restarting internal combustion engine 1 is suppressed.

1. A method for controlling an air-fuel ratio of an internal combustion engine provided with an exhaust purifying catalyst having an oxygen storage capacity in an exhaust passage by controlling the air-fuel ratio such that an oxygen storage amount of the exhaust purifying catalyst becomes a target oxygen storage amount, the method comprising:
estimating the oxygen storage amount of the exhaust purifying catalyst based on an air-fuel ratio of an exhaust gas flowing into the exhaust purifying catalyst;
controlling the air-fuel ratio of the internal combustion engine such that the estimated oxygen storage amount matches the target oxygen storage amount;
detecting an air-fuel ratio of an exhaust gas flowing out of the exhaust purifying catalyst, on a downstream side of the exhaust purifying catalyst;
resetting the estimated oxygen storage amount to a predetermined first oxygen storage amount which is smaller than the target oxygen storage amount when it is detected that the oxygen storage amount of the exhaust purifying catalyst is equal to or smaller than the first oxygen storage amount based on the air-fuel ratio of the exhaust gas flowing out of the exhaust purifying catalyst; and
resetting the estimated oxygen storage amount to a predetermined second oxygen storage amount which is larger than the target oxygen storage amount when it is detected that the oxygen storage amount of the exhaust purifying catalyst is equal to or larger than the second oxygen storage amount based on the air-fuel ratio of the exhaust gas flowing out of the exhaust purifying catalyst,
wherein the target oxygen storage amount is set within a range where the oxygen storage amount is smaller than a median of the first oxygen storage amount and the second oxygen storage amount.

2. The method for controlling the air-fuel ratio of the internal combustion engine according to claim 1, wherein the first oxygen storage amount is larger than 10% of a maximum oxygen storage amount of the exhaust purifying catalyst, and
wherein the second oxygen storage amount is smaller than 90% of the maximum oxygen storage amount of the exhaust purifying catalyst.

3. The method for controlling the air-fuel ratio of the internal combustion engine according to claim 2, wherein the target oxygen storage amount is smaller than 40% of the maximum oxygen storage amount of the exhaust purifying catalyst.

4. The method for controlling the air-fuel ratio of the internal combustion engine according to claim 2, wherein the first oxygen storage amount is 20% of the maximum oxygen storage amount of the exhaust purifying catalyst, and
wherein the second oxygen storage amount is 60% of the maximum oxygen storage amount of the exhaust purifying catalyst.

5. The method for controlling the air-fuel ratio of the internal combustion engine according to claim 4, wherein the target oxygen storage amount is 35% of the maximum oxygen storage amount of the exhaust purifying catalyst.

6. The method for controlling the air-fuel ratio of the internal combustion engine according to claim 1, wherein when a temporary stop of the internal combustion engine is requested, before the temporary stop is executed, operation is performed for setting the air-fuel ratio of the internal combustion engine to be rich such that the oxygen storage amount of the exhaust purifying catalyst is smaller than the target oxygen storage amount.

7. A device for controlling an air-fuel ratio of an internal combustion engine, comprising:
an exhaust purifying catalyst having an oxygen storage capacity which is provided in an exhaust passage of the internal combustion engine;
an upstream-side air-fuel sensor provided on an upstream side of the exhaust purifying catalyst;
a downstream-side air-fuel sensor provided on an downstream side of the exhaust purifying catalyst; and
a controller configured to control the air-fuel ratio of the internal combustion engine,
wherein the controller is configured to:
estimate an oxygen storage amount of the exhaust purifying catalyst based on an air-fuel ratio detected by the upstream-side air-fuel ratio sensor, and control the air fuel ratio of the internal combustion engine such that the estimated oxygen storage amount matches a target oxygen storage amount; and
reset the estimated oxygen storage amount to a predetermined first oxygen storage amount which is smaller than the target oxygen storage amount when it is detected that the oxygen storage amount of the exhaust purifying catalyst is equal to or smaller than the first oxygen storage amount based on an air-fuel ratio detected by the downstream-side air-fuel ratio sensor, and reset the estimated oxygen storage amount to a predetermined second oxygen storage amount which is larger than the target oxygen storage amount when it is detected that the oxygen storage amount of the exhaust purifying catalyst is equal to or larger than the second oxygen storage amount based on the air-fuel ratio detected by the downstream-side air-fuel ratio sensor,
wherein the target oxygen storage amount is set within a range where the oxygen storage amount is smaller than a median of the first oxygen storage amount and the second oxygen storage amount.
